(19) United States
(12) Patent Application Publication
(10) Pub. No.: US 2002/0114978 A1
(43) Pub. Date: Aug. 22, 2002

(54) Novel magnetic recording media compose of dual non-magnetic spacer layers

(76) Inventors: Ting-Wei Chang, Taichung (TW); Hung-Huei Liang, Hsinchu (TW); Chang-Dar Tsai, Hsinchu Hsien (TW)

Correspondence Address: BACON & THOMAS, 625 Slaters Lane - 4th Floor, Alexandria, VA, 22314, US

(21) Appl. No.: 09/741,063

(22) Filed: Dec. 21, 2000

(51) Int. Cl. G11B 5/66

(52) U.S. Cl. 428/694 TM

(57) ABSTRACT

A magnetic recording medium has a substrate, an underlayer on the substrate, a multiple-laminated magnetic layer, a non-magnetic CoCr-based interlayer interposed between the multiple-laminated magnetic layer and the underlayer, and a protecting layer coated on the multiple-laminated magnetic layer. The multiple-laminated magnetic layer having at least a lower magnetic layer deposited, a spacer layer deposited on the lower magnetic layer, a upper magnetic layer deposited on the spacerII layer, and a non-magnetic CoCr-based spacerII layer deposited between the upper magnetic layer and the spacer layer. The multiple-laminated magnetic layer is used to record data. The non-magnetic CoCr-based spacerII layer is used to enhance preferred orientation and lattice matching between the upper magnetic layer and the spacer layer.

### FIELD OF THE INVENTION

The present invention relates to a magnetic recording medium. More specifically, the present invention discloses a magnetic recording medium with a high signal-to-noise ratio (SNR) at high linear recording densities.

### BACKGROUND OF THE INVENTION

Hard disk drives, the main data storage device in computer system, were required to increase speed and capacity rapidly accompany with continually progress in information technology. To enhance the capability of hard disk drive, one of the important things is to improve the signal-to-noise ratio performance of the hard disks medium during recording. Specially, the magnetic properties of the medium should be enhanced.

The magnetic requirements for high density medium include high value of coercivity (Hc), reduced remanent moment density (Mrt), and, increased signal-to-noise ratio (SNR), etc. Additionally, the medium should exhibit a high square hysteresis loop as defind by the squareness (S) and the coercive squareness (S*). These parameters largely determine the data storage capacities of magnetic recording medium.

Coercivity and Signal-to-Noise Ratio, certain key factors, affecting the storage density of a magnetic recording medium are explained as follows:

(a) Coercivity: It is defined as the magnetic field required to reduce remanence magnetic moment to zero. A higher coercivity is associated with a higher information storage density by allowing adjacent recording bits to be placed more closely without mutual cancellation or interference. Most materials used in the industry have an Hc greater than 3000 oersteds (Oe).

(b) Signal-to-Noise Ratio: It is defined as 20×log[Signal Voltage/Noise Voltage]. A higher SNR is associated with a high bit density to be read with a given degree of reliability since a greater signal can be detected in a low noise reading operation.

As shown in FIG. 1, conventional magnetic recording medium comprises a substrate 1, covered by an underlayer 2, in turn, covered by a magnetic layer 3. The magnetic layer 3 may be covered by an overlayer to protect the magnetic layer 3. The underlayer 2 is usually composed of a Cr-based alloy and functions as a crystalline template for lattice matching during epitaxial deposition of the magnetic layer 3. The underlayer 2 is a body centered cubic (bcc) crystalline structure of this Cr-based alloy. The magnetic layer 3 is usually a Co-based alloy with hexagonal-close packed (hcp) crystalline structure horizontal lying on the surface of disks which is sufficient enough to allow for higher coercivities and lower noise.

In order to ensure the structure of the magnetic layer 3, the crystalline structure of the underlayer 2 should closely match that of the Co-based alloy. Unfortunately, the crystalline structure of the Cr-based underlayer 2 does not always adequately match that of the Co-based recording layer. This, in turn, leads to lattice mismatching that reduces the performance of the magnetic layer 3. Therefore, the interlayer 5 shown as FIG. 2 is deposited between the underlayer 2 and the magnetic layer 3. The interlayer 5 is to invite a CoCr based alloy with hexagonal-close packed crystalline structure between body centered cubic Cr-based underlayer 2 and hexagonal-close packed Co-based magnetic layer 3 to reduce the mismatching of lattice. Besides, it also increases the magnetic layer 3 moments per unit volume located at the preferred orientation.

In a conventional magnetic recording medium, the single magnetic layer 3 does not satisfy the requirement for high signal-to-noise ratio. It is known that media noise is reduced when grains of the magnetic layer are subdivided into small and isolated exchange decouple particles. In practice, however, the grains in the single magnetic layer are contiguous and more coupled, causing higher noise when increase the density of the magnetic transitions. Hence, there is a need in the art for making a magnetic recording medium with low noise and high signal; that is, high SNR at high recording densities.

### SUMMARY OF THE INVENTION

Accordingly, it is an object of the invention to provide a magnetic recording medium with high SNR at high recording densities.

It is an objective of the present invention is to provide a magnetic recording medium with a spacerII layer 64 shown as FIG. 4 that improves preferred orientation and lattice matching of overlying magnetic layers.

In one aspect, the invention includes an improvement in a magnetic recording medium formed on a rigid substrate and having an underlayer, an interlayer, at least one multiple-laminated magnetic layer, a non-magnetic interlayer interposed between the multiple-laminated magnetic layer and the underlayer, and diamond-like protecting layer coated on the multiple-laminated magnetic layer. The multiple-laminated magnetic layer having at least a lower magnetic layer deposited, a spacer layer deposited on the lower magnetic layer, and an upper magnetic layer deposited on the spacer layer. A non-magnetic CoCr-based spacerII layer deposited between the upper magnetic layer and the spacer layer. The multiple-laminated magnetic layer is used to record data. The non-magnetic CoCr-based spacerII layer is used to enhance preferred orientation and lattice matching between the upper magnetic layer and the spacer layer, and thus enhances the SNR of the magnetic recording medium.

In another aspect, it is an advantage of the present invention that the multiple-laminated magnetic layer structure comprising magnetic layer separated by non-magnetic spacer films, achieves smaller grain size and lower media noise. Additionally, by reducing lattice mismatching between upper magnetic layer and spacer layer, the spacerII layer improves the magnetic remanence (Mr) of the upper magnetic layer. As well, the spacerII layer improves the SNR for reading and writing operations.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a cross-sectional view of a magnetic recording medium formed on a substrate and having an underlyer, a magnetic layer, and diamond-like protecting layer coated on the magnetic layer;

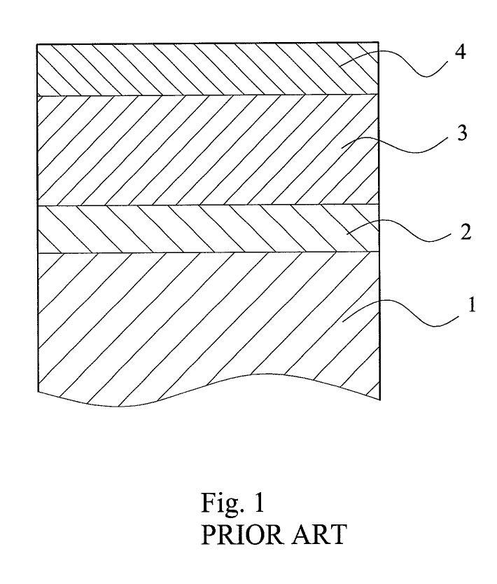

FIG. 2 is a cross-sectional view of a magnetic recording medium formed on a substrate and having an underlyer, an interlayer, a magnetic layer, and diamond-like protecting layer coated on the magnetic layer;

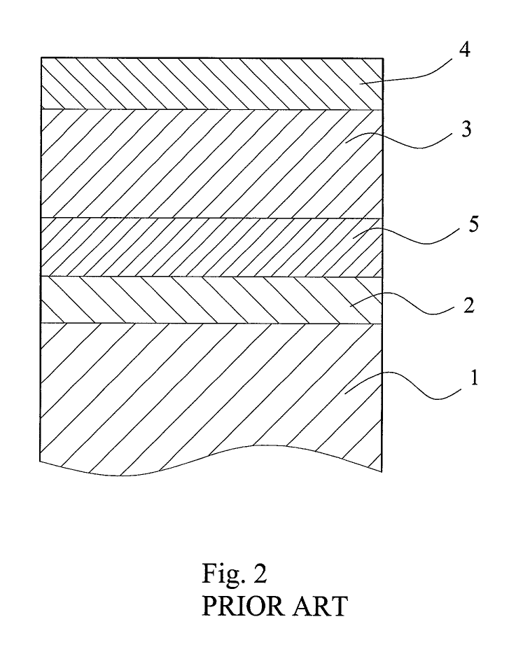

FIG. 3 is a cross-sectional view of a magnetic recording medium formed on a substrate and having an underlyer, an interlayer, a multiple-laminated magnetic layer, a non-magnetic interlayer interposed between the multiple-laminated magnetic layer and the underlayer, and diamond-like protecting layer coated on the multiple-laminated magnetic layer;

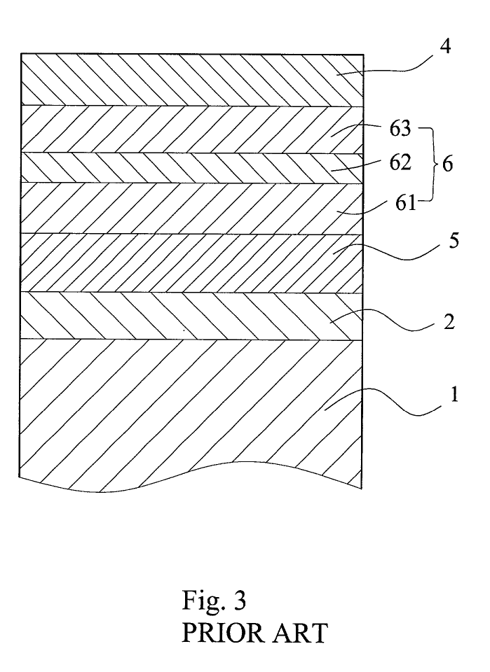

FIG. 4 is a cross-sectional view of a magnetic recording medium according to the present invention;

FIG. 5 is a plot of low frequency track average amplitude (LFTAA), in mV, as a function of spacerII layer thickness, in Å, for a medium when using the present invention spacerII layer;

FIG. 6 is a plot of remanence (Mr), in emu/cm³, as a function of spacerII layer thickness, in Å, for a medium when using the present invention spacerII layer;

FIG. 7 is a plot of signal-to-noise ratio (SNR), in dB, as a function of spacerII layer thickness, in Å, for a medium when using the present invention spacerII layer.

### DETAILED DESCRIPTION OF THE PREFERRED EMBODIMENTS

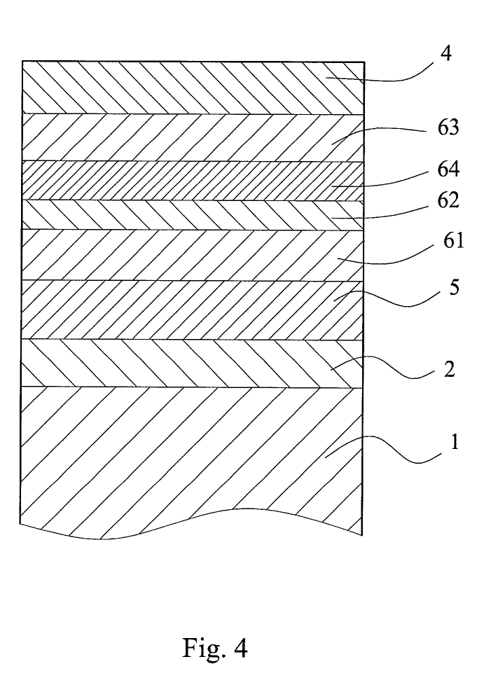

Please refer to FIG. 4. FIG. 4 is described a cross-sectional structure of a magnetic recording medium according to the present invention. The magnetic recording has a substrate 1, an underlayer 2 deposited on the substrate 1, an interlayer 5 deposited on the underlayer 2, a multiple-laminated magnetic layer 6 on the interlayer 5, and a protecting layer 4 on the multiple-laminated magnetic layer 6.

The multiple-laminated magnetic layer 6 is used for the storage and retrieval of magnetically encoded information. The multiple-laminated magnetic layer 6 includes lower magnetic layer 61, a spacer layer 62, a spacerII layer 64, and a upper magnetic layer 63. The protecting layer 4 provides to protect the multiple-laminated magnetic layer 6 from scratches and damage during use, and is, in the preferred embodiment, a diamond-like carbon (DLC) coating less than 100 angstroms (Å) thick. The DLC coating of the protecting layer 4 is deposited on the surface of the multiple-laminated magnetic layer 6 by known techniques in the art.

Sputtering is used to form the underlayer 2, the interlayer 5, each layer of the multiple-laminated magnetic layer 6, and the protecting layer 4. A sputtering chamber is evacuated to a pressure of about 10⁻⁷ Torr at the beginning of the sputtering process. Argon is then introduced into the chamber to achieve a final sputtering pressure of approximately 10⁻² to 10⁻³ Torr. The substrate 1 is the first heated to a temperature of approximately 200-300° C. and the underlayer 2 is the then sputtered onto the substrate 1. Thereafter, the interlayer 5 and the multiple-laminated magnetic layer 6 are sequentially sputtered over the underlayer 2. To form the multiple-laminated magnetic layer 6, the lower magnetic layer 61 is the first sputtered onto the interlayer 5. The spacer layer 62 and the spacerII layer 64 are sequentially sputtered onto the lower magnetic layer 61. The upper magnetic layer 63 is then sputtered onto the spacerII layer 64.

The substrate 1 may be a texture substrate, such as a conventional surface-coated, textured aluminum substrate of the type used commonly for digital recording medium, aluminum alloy, a texture glass, a ceramic substrate, or glass-ceramic materials. Typically, aluminum/magnesium or glass substrates are the first plated with a selected alloy plating, such as a nickel/phosphorus or nickel/aluminum plating, to achieve a requisite surface hardness, with the thickness of the plating being about 300-700 micro-inches.

The underlayer 2 is preferably a chromium alloy. When the crystal lattice of the underlayer 2 alloy matches the crystal lattice of the lower magnetic layer 61 alloy this allows higher in plane coercivities and lower Read/Write noise and, as a result, better recording performance. This underlayer 2 has a crystalline structure of a (200) epitaxial growth preferred orientation and functions as a template for the crystalline structure of the lower magnetic layer 61. The thickness of underlayer is about 45-450 Å.

The interlayer 5 is a non-magnetic layer deposited between the underlayer 2 and the lower magnetic layer 61 by sputtering. The interlayer 5 functions in reducing lattice mismatching between the underlayer 2 and the lower magnetic layer 61 due to a crystalline structure that is essentially the same as the crystalline structure of the lower magnetic layer 61. Furthermore, the interlayer 5 increases the magnetic moments per unit volume with the preferred orientation in the multiple-lamination magnetic layer 6. Consequently, the interlayer 5 helps to significantly improve the SNR of the multiple-lamination magnetic layer 6.

The interlayer 5 is composed of a non-magnetic CoCr-based alloy that has a thickness of between 70-450 Å, and has a CoCrXY formula. The X representing a metal soluble material that is soluble with Co and Cr, such as vanadium, molybdenum, ruthenium, titanium, manganese, etc., and the Y elements contains any elements or compounds which is insoluble with Co, Cr, or X elements, such as boron, tantalum, niobium, zirconium, tungsten, or oxides. The interlayer 5 contains 30-65 atomic percent of cobalt, and 18-65 atomic percent of chromium.

It is known that media noise is reduced when grains of the magnetic layer are subdivided into small and isolated particles. In practice, however, the grains in the single magnetic layer are contiguous and coupled, causing noise to increase with the density of the magnetic transitions. Hence, there is a need in the art for making a magnetic recording medium with low noise, and a high signal; that is, high SNR at high recording densities. The magnetic layer 3 is separated by the spacer layer 62 which is preferably a formed of a chromium alloy. The spacer layer 62 is deposited between lower magnetic layer 61 and upper magnetic layer 63. The thickness of spacer layer 62 is about 3-10 Å.

Both the lower magnetic layer 61 and upper magnetic layer 63 are made from a CoCrPt-based alloy, preferably a CoCrPtTa alloy or a CoCrPtTaB alloy. The total thickness of the multiple-laminated magnetic layers should preferably be about 60-200 Å.

Of key importance to the present invention is the spacerII layer 64, applied to the to the multiple-laminated magnetic layer 6 structure by sputtering onto the spacer layer 62. The spacerII layer 64 is a non-magnetic layer deposited between the spacer layer 62 and the upper magnetic layer 63. The spacer II layer 64 has a thickness of between 5-50 Å, and has a CoCrXY formula. The X representing a metal soluble material that is soluble with Co and Cr, such as vanadium, molybdenum, ruthenium, titanium, manganese, etc., and the Y elements contains any elements or compounds which is insoluble with Co, Cr, or X elements, such as boron, tantalum, niobium, zirconium, tungsten, or oxides. The interlayer 5 contains 30-65 atomic percent of cobalt, and 18-65 atomic percent of chromium.

In order to ensure the structure of the upper magnetic layer 63, the crystalline structure of the spacer layer 62 should closely match that of the Co-based alloy. Unfortunately, the crystalline structure of the Cr-based spacer layer 62 does not always adequately match that of the Co-based recording layer. This, in turn, leads to lattice mismatching that reduces the performance of the upper magnetic layer 63. Therefore, the spacerII layer 64 is deposited between the spacer layer 62 and the upper magnetic layer 63. The spacerII layer 64 is to invite a hexagonal-close packed crystalline structure between body centered cubic Cr-based spacer layer 62 and hexagonal-close packed Co-based upper magnetic layer 63 to reduce the mismatching of lattice. Besides, it also increases the upper magnetic layer 63 moments per unit volume located at the preferred orientation.

The following table illustrates the improved characteristics of the present invention. In the following table, LFTAA is the low frequency track average amplitude, in units of mV, and SNR is the signal-to-noise ratio, in units of dB. Each was obtained by Guzik tester commonly used in this field. Mr is the remanence, in units of emu/cm³, obtained by remanence magnetometer.

TABLE 1

| SpacerII layer | | | |
|---|---|---|---|
| Thickness | LFTAA | Mr | SNR |
| (Å) | (mV) | (emu/cm³) | (dB) |
| 0 | 1.441 | 223 | 23.68 |
| 10 | 1.510 | 233 | 23.93 |
| 20 | 1.521 | 237 | 24.07 |
| 30 | 1.558 | 241 | 24.12 |
| 40 | 1.564 | 248 | 24.34 |
| 50 | 1.605 | 252 | 24.20 |

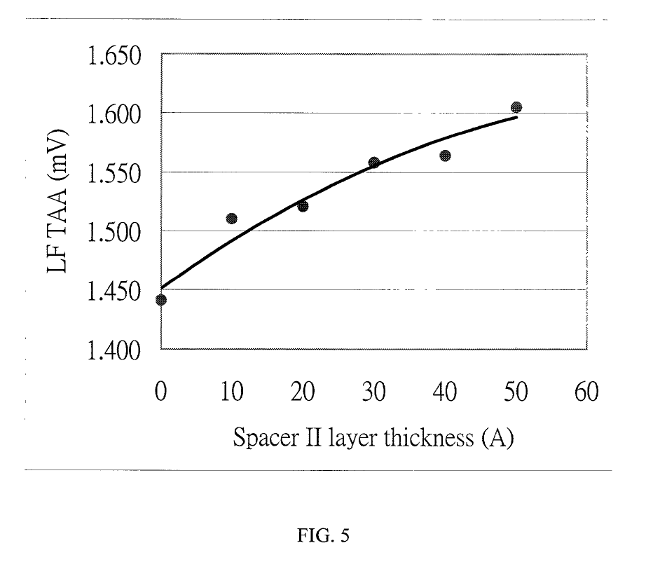

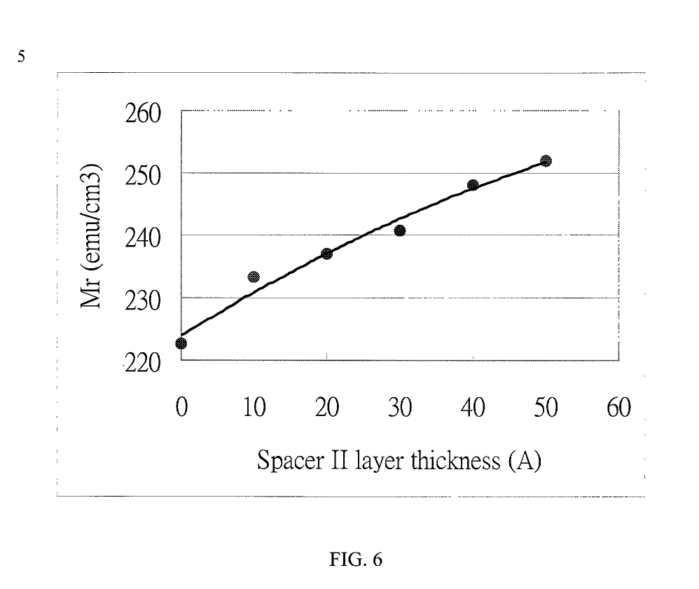

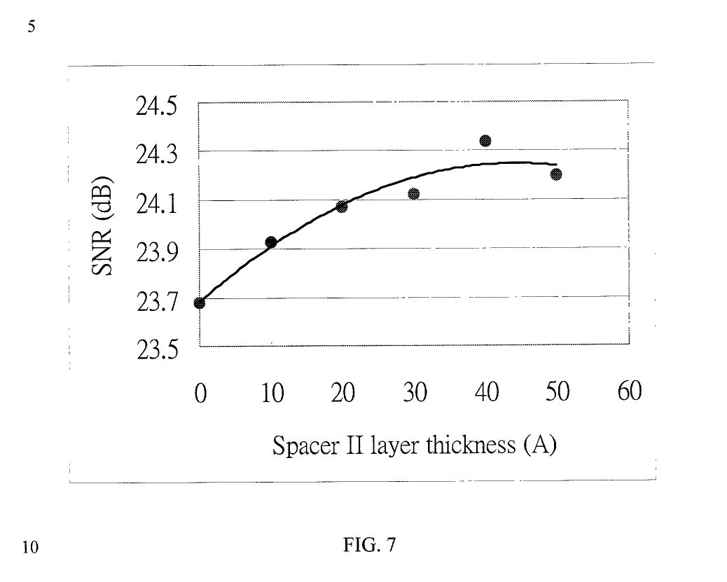

The multiple-laminated magnetic layer 6 with the spacerII layer 64 of the present invention shows a marked improvement over an identical multiple-laminated magnetic layer 6 without the present invention spacerII layer 64. The improvement is further illustrated in FIG. 5, which shows a graph of the LFTAA versus the spacerII layer 64 thickness. FIG. 6 shows a graph of the Mr versus the spacerII layer 64 thickness. FIG. 7 shows a graph of the SNR versus the spacerII layer 64 thickness. When the present invention spacerII layer thickness is zero, the multiple-laminated magnetic layer 6 is without the present invention spacerII layer 64. In all of the graphs from FIG. 5 to FIG. 7, distinct improvements are observed in the characteristics of the multiple-laminated magnetic layer 6 when utilizing the non-magnetic spacerII layer 64 of the present invention. The most significant is the improvement of the SNR obtained by using the spacerII layer 64. In contrast to the prior art, the present invention uses a CoCr-based alloy as spacerII layer 64 between upper magnetic layer 63 and spacer layer 62. The spacerII layer 64 is non-magnetic and presents a hcp crystalline structure that is desirable and essentially identical to that of the magnetic recording layer, thus reducing lattice mismatching between upper magnetic layer 63 and spacer layer 62. By improving the crystallographic structure of the upper magnetic layer 63, the present invention spacerII layer increases the number of magnetic moments per unit volume with a preferred orientation in the upper magnetic layer 63. The results are an improved LFTAA, Mr, and SNR.

These skills in the art will be readily observed that numerous modifications and alterations of the device may be made while retaining the teachings of the invention. Accordingly, the above disclosure should be construed as limited only by the metes and bounds of the appended claims.

What is claimed is:

1. A magnetic recording medium comprising:
a substrate;
an underlayer formed on the substrate;
a multiple-laminated magnetic layer for recording data formed over the underlayer, the multiple-laminated magnetic layer having at least a lower magnetic layer deposited, a spacer layer deposited on the lower magnetic layer, a upper magnetic layer deposited on the spacerII layer, and a non-magnetic CoCr-based spacerII layer deposited between the upper magnetic layer and the spacer layer for preferred orientation and lattice matching improvement of upper magnetic layer;
a non-magnetic CoCr-based interlayer interposed between the multiple-laminated magnetic layer and the underlayer; and
a protecting layer coated on the multiple-laminated magnetic layer.

2. The magnetic recording medium of claim 1, wherein said substrate is composed of, aluminum, aluminum alloys, glass, ceramic, or glass-ceramic materials.

3. The magnetic recording medium of claim 1 wherein said substrate is an AlMg-based substrate, a NiP layer is further coated on the surface of the aluminum substrate to enhance both the rigidity and the smoothness of the aluminum substrate.

4. The magnetic recording medium of claim 1 wherein said substrate is an glass substrate, a NiP or NiAl layer is further coated on the surface of the glass substrate to enhance both the rigidity and the smoothness of the glass substrate.

5. The magnetic recording medium of claim 1 wherein said underlayer is composed of a Cr-base alloy containing molybdenum, vanadium, ruthenium, or tungsten, etc., and the thickness of underlayer is about 45-450 Å.

6. The magnetic recording medium of claim 1 wherein said non-magnetic CoCr-based interlayer has a thickness of between 70-450 Å, and has a CoCrXY formula.

7. The magnetic recording medium of claim 6 wherein said X representing a metal soluble material that is soluble with Co and Cr, such as vanadium, molybdenum, ruthenium, titanium, manganese, etc., and Y elements contains any elements or compounds which insoluble with Co, Cr, or X elements, such as boron, tantalum, niobium, zirconium, tungsten, or oxides.

8. The magnetic recording medium of claim 6 wherein said non-magnetic CoCr-based interlayer contains 30-65
atomic percent of cobalt, and 18-65 atomic percent of chromium.

9. The magnetic recording medium of claim 1 wherein said lower magnetic layer is composed of a CoCrPt-based alloy, and the thickness is about 30-100 Å.

10. The magnetic recording medium of claim 1 wherein said spacer layer composed of a Cr-based alloy, and the thickness is about 3-10 Å.

11. The magnetic recording medium of claim 1, wherein said non-magnetic CoCr-based spacerII layer has a thickness of between 5-50 Å, and has a CoCrXY formula.

12. The magnetic recording medium of claim 11, wherein said X representing a metal soluble material that is soluble with Co and Cr, such as vanadium, molybdenum, ruthenium, titanium, manganese, etc., and Y elements contains any elements or compounds which insoluble with Co, Cr, or X elements, such as boron, tantalum, niobium, zirconium, tungsten, or oxides.

13. The magnetic recording medium of claim 11, wherein said non-magnetic CoCr-based spacerII layer contains 30-65 atomic percent of cobalt, and 18-65 atomic percent of chromium.

14. The magnetic recording medium of claim 1, wherein said non-magnetic CoCr-based spacerII layer has a hexagonal-closed-packed (hcp) crystalline structure.

15. The magnetic recording medium of claim 1 wherein said upper magnetic layer is composed of a CoCrPt-based alloy, and the thickness is about 30-100 Å.

16. The magnetic recording medium of claim 1 wherein said total thickness of the lower and upper magnetic layer is approximately 60-200 Å.

17. The magnetic recording medium of claim 1 wherein said protecting layer is diamond-like carbon (DLC) and the thickness of the protecting layer is less than 100 Å.
